(19) United States
(12) Patent Application Publication
(10) Pub. No.: US 2018/0106257 A1
(43) Pub. Date: Apr. 19, 2018

(54) PORTABLE DUNNAGE BAG INFLATION SYSTEM

(71) Applicant: Signode Industrial Group LLC, Glenview, IL (US)

(72) Inventors: Anthony K. Beard, Pyen, AR (US); Joseph W. Gault, Sheridan, AR (US); Thomas A. Ketzer, Hensley, AR (US); Thomas C. Keenan, Brentwood, TN (US)

(21) Appl. No.: 15/728,187

(22) Filed: Oct. 9, 2017

Related U.S. Application Data
(60) Provisional application No. 62/409,308, filed on Oct. 17, 2016.

(51) Int. Cl. F04D 17/16; F04D 29/28; F04D 25/06

(52) U.S. Cl. CPC F04D 17/16; B60P 7/065; F04D 25/06; F04D 29/281

(57) ABSTRACT

Various embodiments provide a compact, portable dunnage bag inflation system that provides an air source that is easily carried by a user via a wearable container. Generally, the dunnage bag inflation system includes a portable dunnage bag inflator having an air generator that, in operation, expels air through an outlet. One end of a hose is removably connectable to the air generator to fluidly connect the hose and the outlet. An inflator head that includes a button actuatable to operate the portable dunnage bag inflator is connected to an opposing end of the hose. The dunnage bag inflation system also includes a rechargeable battery electrically connectable to the portable dunnage bag inflator to power the inflator and a charging station to charge the battery. This enables dunnage bags to be inflated to desired specifications at point-of-use and eliminates the need for a compressed air supply.

### PRIORITY

This application claims priority to and the benefit of U.S. Provisional Patent Application Ser. No. 62/409,308, filed Oct. 17, 2016 and entitled PORTABLE DUNNAGE BAG INFLATION SYSTEM, the entire contents of which are incorporated herein by reference.

### BACKGROUND

Inflatable dunnage bags are commonly used to stabilize cargo during transportation of cargo containers (such as railroad cars and semi-trailers), which improves safety and reduces the likelihood of damage to the cargo. Generally, after some or all of the cargo is loaded into a cargo container, one or more dunnage bags are positioned in any voids or spaces between the cargo and/or between the cargo and the walls of the cargo container. The dunnage bags are inflated to a designated operating pressure using a pneumatic source. In most known implementations in the load securement industry, a pneumatic compressor is employed as the pneumatic source. This pneumatic compressor is typically a large-scale, stationary pneumatic compressor centrally located in the warehouse or factory from which the cargo is being transported.

Typically, users inflate the dunnage bags within the cargo container (i.e., at point-of-use) using the stationary pneumatic compressor. In these instances, the user locates a compressed air hose connected to the stationary pneumatic compressor and brings the compressed air hose into the cargo container. The user then positions the inflated dunnage bags in the void(s) or space(s) and inflates the dunnage bags using the compressed air hose (and an appropriate inflator tool).

Various problems arise in these instances. Because the compressed air hose is typically stored at the stationary pneumatic compressor, it is time consuming for the user to travel to retrieve the compressed air hose whenever the user desires to inflate a dunnage bag. Since the compressed air hose has a finite length, in some instances the compressed air hose may be too short to reach the cargo container and, therefore, the stationary pneumatic compressor is not able to deliver the compressed air at the point-of-use to inflate the dunnage bag(s). In other words, in these instances, there is no way to route the compressed air from the stationary pneumatic compressor to the dunnage bag(s) to inflate the dunnage bag(s) and, therefore, more time-consuming, less environmentally friendly, and more expensive solutions must be employed.

Additionally, the long compressed air hose itself can be problematic as it can snag, rip, or cause a tripping hazard within the warehouse or factory. Further, since the stationary pneumatic compressor by definition employs compressed air to fill the dunnage bag(s), one must pay for the energy to manufacture the compressed air, pay to store and maintain the compressed air, pay for floor space to store the pneumatic compressor itself, and pay for any required maintenance when the pneumatic compressor breaks down. Additionally, in instances in which the user desires to position and inflate dunnage bags intermittently during loading of the cargo, the user must repeatedly bring the compressed air hose back and forth into and out of the cargo container to ensure that the compressed air hose does not interfere with the loading of the cargo, which adds substantial time to the cargo loading process.

Accordingly, there is a need for new and improved ways to solve these problems.

### SUMMARY

Various embodiments of the present disclosure provide a compact, portable dunnage bag inflation system that provides an air source that is easily carried by a user via a wearable container. Generally, the dunnage bag inflation system includes a portable dunnage bag inflator having an air generator that, in operation, expels air through an outlet. One end of a hose is removably connectable to the air generator to fluidly connect the hose and the outlet. An inflator head that includes a button actuatable to operate the portable dunnage bag inflator is connected to an opposing end of the hose. The dunnage bag inflation system also includes a rechargeable battery electrically connectable to the portable dunnage bag inflator to power the inflator and a charging station to charge the battery. This enables dunnage bags to be inflated to desired specifications at point-of-use and eliminates the need for a remote compressed air supply.

In one embodiment, the portable dunnage bag inflator of the present disclosure includes (a) an air generator including: (i) a housing, (ii) an outlet, (iii) an impeller mounted within the housing, (iv) a motor mounted within the housing and operably connected to the impeller to drive the impeller to expel air through the outlet, and (v) a wireless receiver communicatively connected to the motor; (b) a hose having a first end and a second end opposite the first end, the hose defining an air passageway extending between the first end and the second end, the first end attachable to the housing to fluidly connect the outlet of the air generator and the air passageway of the hose; and (c) an inflator head connectable to the second end of the hose and including a wireless transmitter configured to communicate with the wireless receiver to operate the air generator.

In another embodiment, the portable dunnage bag inflation system includes (a) a dunnage bag inflator including: (i) an air generator including a housing, an outlet, an impeller mounted within the housing, and a motor mounted within the housing and operably connected to the impeller to drive the impeller to expel air through the outlet, and (ii) first wiring that extends from the air generator, is electrically connected to the motor, and is electrically connectable to second wiring of a battery to power the motor; and (b) a charging station including: (i) a charging station housing, (ii) a socket configured to receive the second wiring of the battery to charge the battery, and (iii) a charger electrically connected to the socket of the charging station, the charger electrically connectable to a power source to charge the battery when the socket receives the second wiring of the battery.

In another embodiment, the portable dunnage bag inflation system includes (a) a dunnage bag inflator including: (i) an air generator including a housing, an outlet, an impeller mounted within the housing, and a motor mounted within the housing and operably connected to the impeller to drive the impeller to expel air through the outlet, (ii) first wiring that extends from the air generator and is electrically connected to the motor, and (iii) a first electrical connector at an end of the first wiring; and (b) a battery including: (i) a battery casing, (ii) second wiring that extends from the battery casing, and (iii) a second electrical connector at an end of the second wiring, the second electrical connector connectable to the first electrical connector to electrically connect the battery to the air generator.

The portable dunnage bag inflation system of the present disclosure solves the above-described problems. More specifically, since the portable dunnage bag inflation system is highly mobile as a result of a user being able to carry the portable dunnage bag inflator and the battery via a wearable container, a user may inflate dunnage bags immediately after loading cargo into a cargo container. In instances in which a compressed air hose is typically brought to the cargo container to inflate dunnage bags, the portable dunnage bag inflation system of the present disclosure eliminates the wasted time required to locate the compressed air hose, bring the compressed air hose to the cargo container, and return the compressed air hose to the proper location. The portable dunnage bag inflation system of the present disclosure also eliminates the potential safety hazard caused by the compressed air hose laying around the floor of the warehouse or factory.

Further, the portable dunnage bag inflation system of the present disclosure eliminates the possibility that the compressed air hose may not be long enough to reach the cargo container. Additionally, since the portable dunnage bag inflation system of the present disclosure is its own source of pressurized air, the portable dunnage bag inflation system reduces or eliminates the need to manufacture compressed air, store and maintain compressed air, find floor space to store the pneumatic compressor itself, and perform maintenance when the pneumatic compressor breaks down. Further, since the portable dunnage bag inflator and the battery of the present disclosure can be carried by the user via the wearable container, in cases in which the user intermittently inflates and positions dunnage bags during loading, the portable dunnage bag inflation system of the present disclosure eliminates the time wasted bringing the compressed air hose back and forth into and out of the cargo container.

Additional features and advantages of the present disclosure are described in, and will be apparent from, the following Detailed Description and the Figures.

### BRIEF DESCRIPTION OF THE DRAWINGS

FIG. 1 is a perspective view of the dunnage bag inflator and the battery of the portable dunnage bag inflation system of the present disclosure.

FIG. 2 is a left-side view of the dunnage bag inflator and the battery of FIG. 1.

FIG. 3 is an exploded, left-side view of the dunnage bag inflator and the battery of FIG. 1.

FIG. 4 is a top perspective view of the pressurized air generator of the dunnage bag inflator of FIG. 1 with the cover and a portion of the impeller of the dunnage bag inflator removed.

FIG. 5 is cross-sectional view of the pressurized air generator of the dunnage bag inflator of FIG. 1 taken substantially along line 5-5 of FIG. 4.

FIG. 6 is an enlarged perspective view of a hose connector of the dunnage bag inflator of FIG. 1.

FIG. 7 is an enlarged perspective view of a first side of the inflator head of FIG. 1.

FIG. 8 is an enlarged perspective view of an opposing second side of the inflator head of FIG. 7.

FIG. 9 is a perspective view of disconnected electrical connectors of the portable dunnage bag inflation system of FIG. 1.

FIG. 10 is a perspective view of the electrical connectors of FIG. 9 when connected.

FIG. 11 is a top view of the inflator and the battery disposed in the wearable container of the portable dunnage bag inflation system of FIG. 1.

FIG. 12 is a top perspective view of the battery received by the charging station of the portable dunnage bag inflation system of FIG. 1.

FIG. 13 is a top perspective view of the battery electrically connected to the charging station of FIG. 12.

FIG. 14 is a top perspective view of a pressurized air generator of an alternative embodiment of the dunnage bag inflator of the present disclosure.

### DETAILED DESCRIPTION

Various embodiments of the present disclosure provide a compact, portable dunnage bag inflation system that provides an air source that is easily carried by a user via a wearable container. Generally, the dunnage bag inflation system includes a portable dunnage bag inflator having an air generator that, in operation, expels air through an outlet. One end of a hose is removably connectable to the air generator to fluidly connect the hose and the outlet. An inflator head that includes a button actuatable to operate the portable dunnage bag inflator is connected to an opposing end of the hose. The dunnage bag inflation system also includes a rechargeable battery electrically connectable to the portable dunnage bag inflator to power the inflator and a charging station to charge the battery. This enables dunnage bags to be inflated to desired specifications at point-of-use and eliminates the need for a compressed air supply.

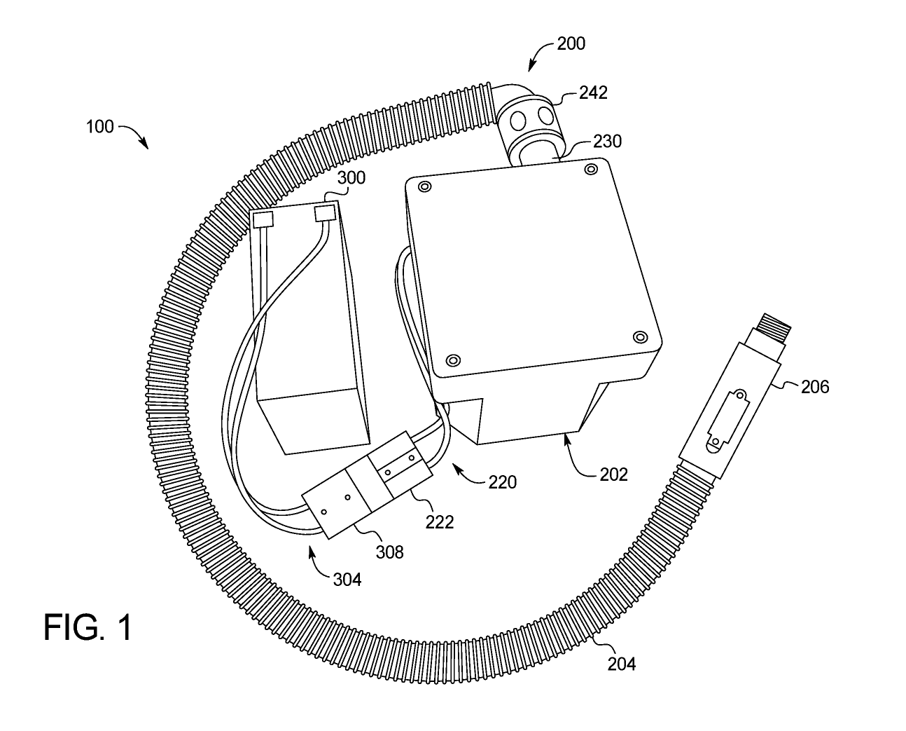

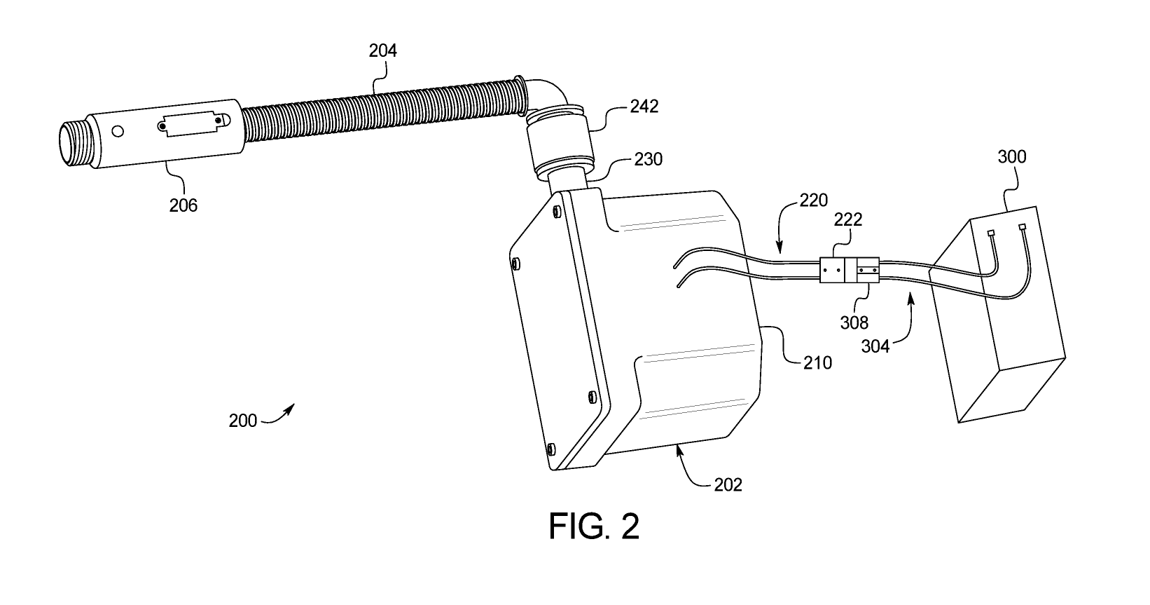

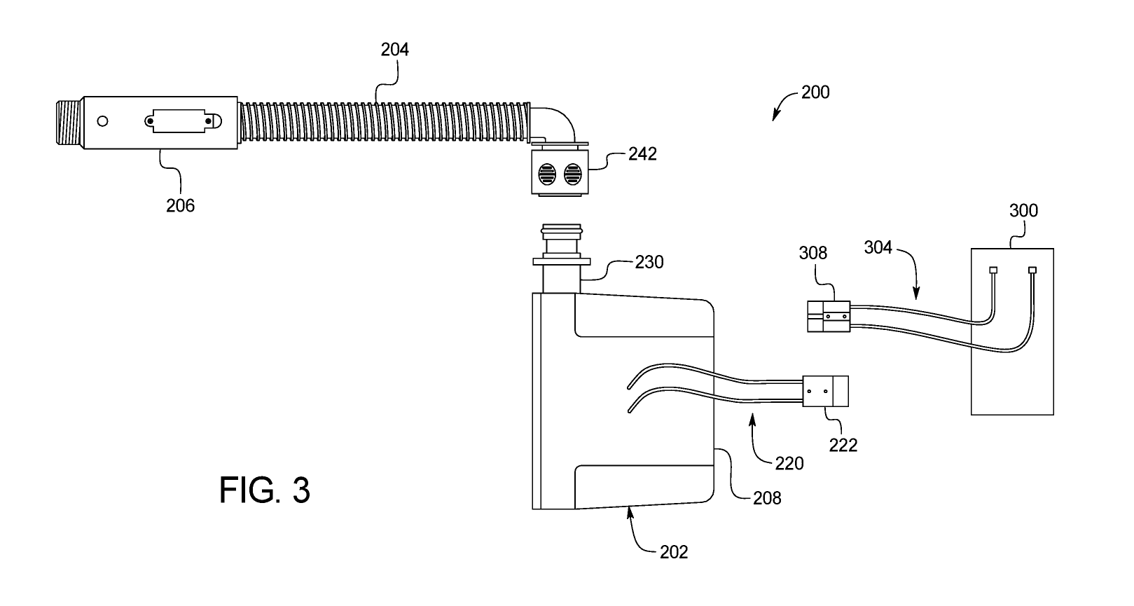

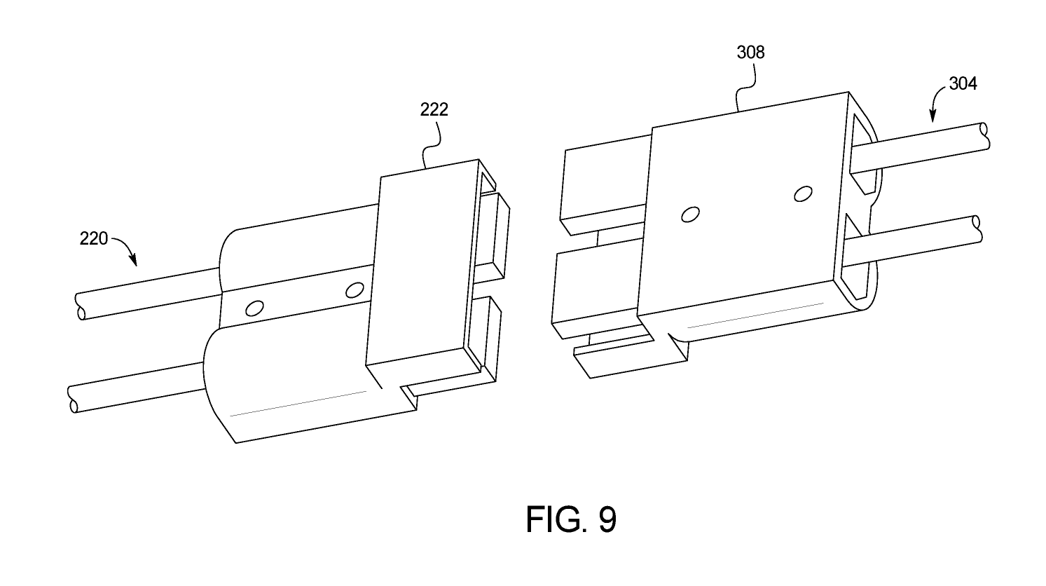

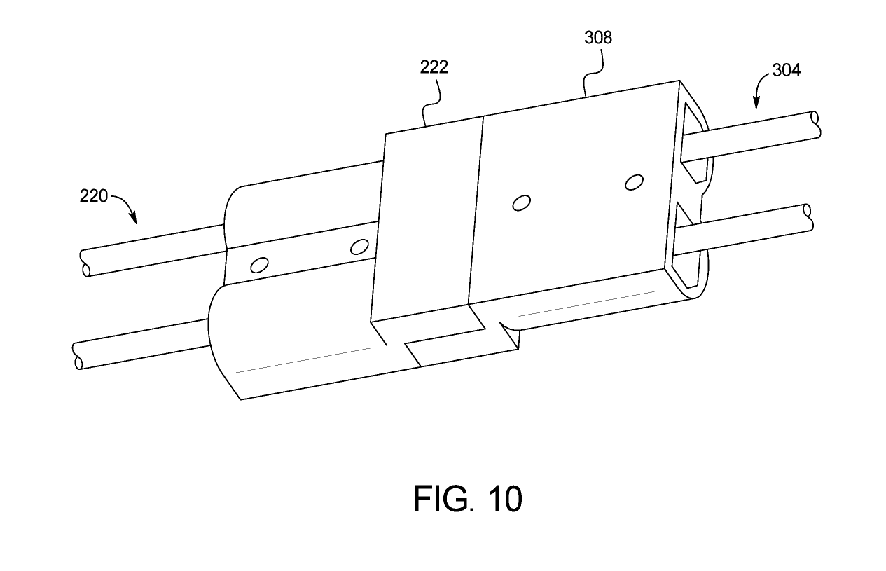

Referring now to the drawings, FIGS. 1 to 13 illustrate one example embodiment of the portable dunnage bag inflation system of the present disclosure, which is generally indicated by numeral 100. In this embodiment, the portable dunnage bag inflation system 100 includes: (1) a portable dunnage bag inflator 200; (2) a battery 300 removably electrically connectable to and configured to power the portable dunnage bag inflator 200; (3) a charging station 400 configured to charge the battery 300; and (4) a wearable container 500 (such as a backpack or other bag) configured to contain the portable dunnage bag inflator 200 and the battery 300 to enable a user to carry and utilize the portable dunnage bag inflator 200 in a mobile manner.

As best shown in FIGS. 1 to 3, the portable dunnage bag inflator 200 includes: (1) a pressurized air generator 202; (2) an inflation hose 204 fluidly connectable to the pressurized air generator 202 and configured to route pressurized air expelled from the pressurized air generator 202; and (3) an inflator head 206 removably connectable to the inflation hose 204 opposite the pressurized air generator 202 and removably connectable to a dunnage bag (not shown) to facilitate filling the dunnage bag with the pressurized air expelled from the pressurized air generator 202 through the inflation hose 204.

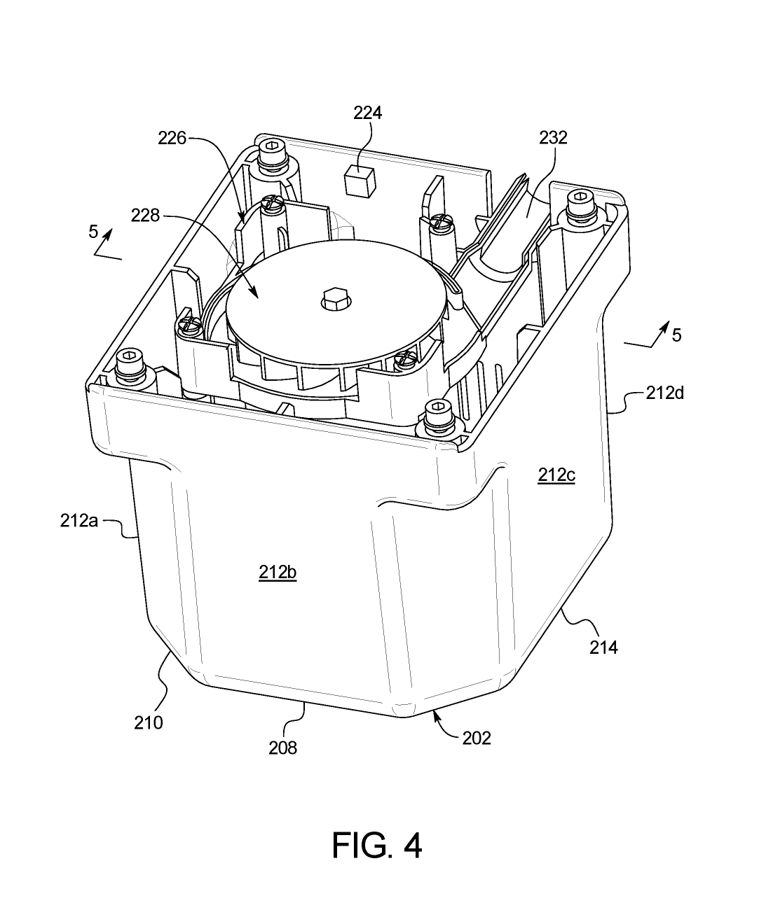

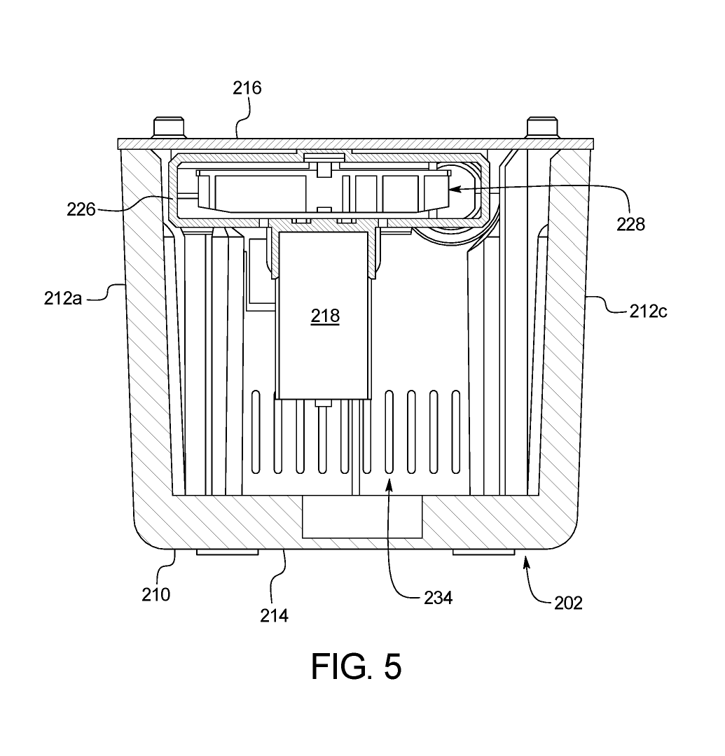

As best shown in FIGS. 4 and 5, the pressurized air generator 202 includes: (1) a housing 208 having (a) a housing base 210 that includes four side walls 212a, 212b, 212c, 212d and a bottom wall 214, and (b) a cover 216 attachable to a top of the housing base 210 to enclose components mounted within the housing 208; (2) an electric motor 218 mounted within the housing 208 and configured to be powered via the battery 300; (3) first wiring 220 extending from the housing 208 and electrically connected to the electric motor 218; (4) a first electrical connector 222 connected to an end of the first wiring 220 and configured to electrically connect the first wiring 220 to the battery 300 to power the electric motor 218 (described below); (5) a wireless receiver 224 mounted within the housing 208, communicatively connected to the electric motor 218, and configured to receive a wireless signal to control operation of the electric motor 218; (6) an impeller housing 226 mounted within the housing 208; (7) an impeller 228 mounted within the impeller housing 226 and operably connected to the electric motor 218 such that the electric motor 218 can drive the impeller 228; and (8) a generator connector 230 that extends through an opening of the side wall 212d and protrudes from the side wall 212d of the housing 208 to define an outlet 232 of the pressurized air generator 202. In certain embodiments, the wireless receiver 224 includes a controller that controls fan operation of the electric motor 218 responsive to the received wireless signals. In other embodiments, the pressurized air generator 202 includes a controller that's separate from and communicatively connected to the wireless receiver 224. In these embodiments, the wireless receiver 224 receives the wireless signals and routes them to (or sends other suitable signals to) the controller, which then controls operation of the electric motor 218 in accordance with those signals.

In this embodiment, the housing 208 defines an air intake or inlet 234 therethrough through which the impeller 228 may draw ambient air. In the illustrated embodiment, the inlet 234 is formed by a grid of openings (such as slots) defined through the side wall 212d of the housing base 210. The openings may be defined through any suitable portion of the housing 208 (such as one or more of the side walls 212a, 212b, 212c, 212d of the housing base 210, the bottom wall 214 of the housing base 210, and/or the cover 216). Additionally, as best shown in FIGS. 1 to 3, the generator connector 230 extends through an opening defined by the side wall 212d of the housing base 210 and defines the outlet 232 through which the impeller 228 expels the pressurized air. While this embodiment includes the pressurized air generator 202 that expels pressurized air, other embodiments include an air transporter or mover that draws in and expels air at ambient pressure (e.g., to fill a dunnage bag). That is, in these alternative embodiments, the air generator does not increase the pressure of the ambient air before expelling it.

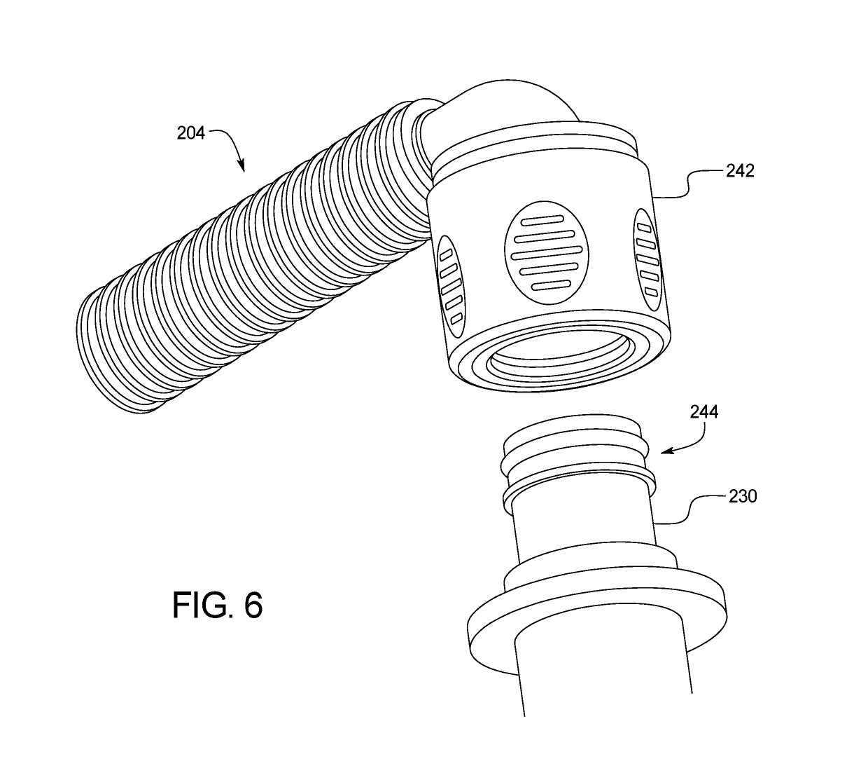

As best shown in FIGS. 1 to 3, the inflation hose 204 of this embodiment: (1) is flexible and expandable; (2) has a first end 236, a second end 238 opposite the first end 236, and an air passageway 240 extending between the first end 236 and the second 238; and (3) includes a hose connector 242 that is attached to the first end 236 and connectable to the generator connector 230 to fluidly connect the air passageway 240 of the inflation hose 204 and the outlet 232 of the pressurized air generator 202. As best shown in FIG. 6, the hose connector 242 includes a quick-connect female connector and the generator connector 230 includes a corresponding quick-connect male connector (or vice versa in other embodiments) having one or more outwardly extending ribs 244 such that hose connector 242 and the generator connector 230 form an airtight seal when connected. This is merely an example, and any suitable types of connectors may be used in accordance with the present disclosure. Further, in certain embodiments, the inflation hose 204 is configured such that the user may replace an inflation hose of one length with another inflation hose of another length as dictated by the particular situation in which the portable dunnage bag inflator 200 is used.

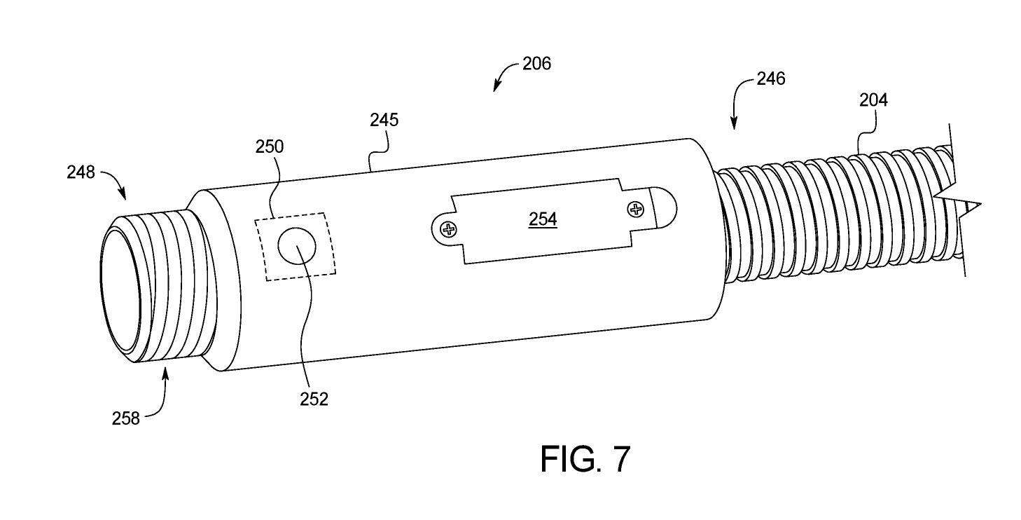

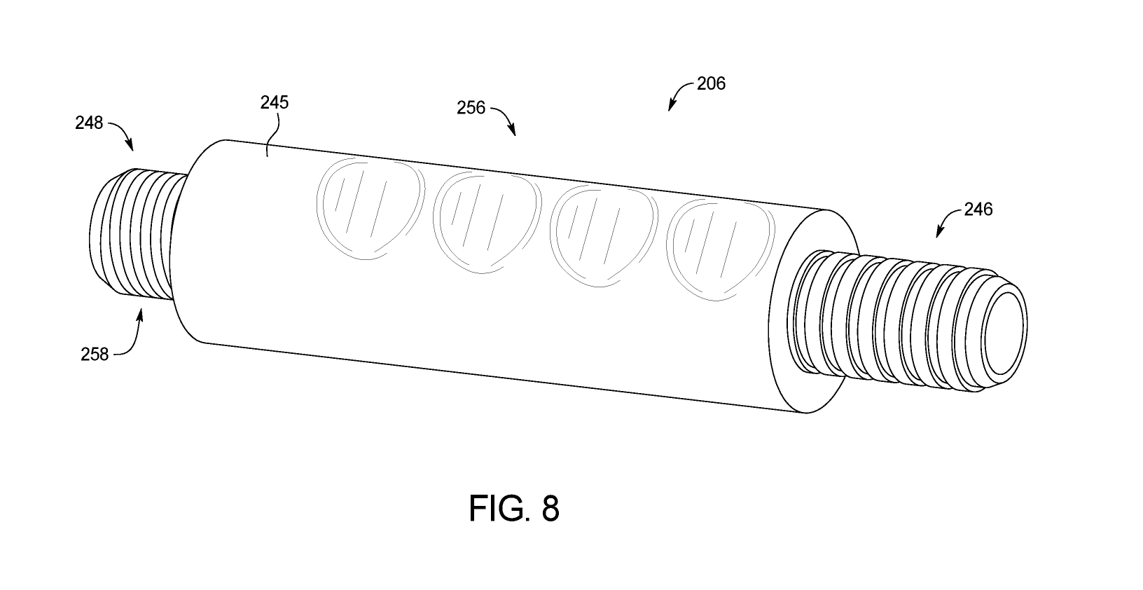

As best shown in FIGS. 7 and 8, the inflator head 206 includes: (1) a housing 245 having a first end 246 that is connectable to the second end 238 of the inflation hose 204 and a second end 248 that is connectable to an inflation implement or device configured to fluidly connect the inflation hose 204 (and therefore the pressurized air generator 202) to a dunnage bag, (2) a wireless transmitter 250 disposed within the housing 245 and configured to wirelessly communicate with the wireless receiver 224 to control operation of the electric motor 218; (3) an actuatable button 252 partially supported by and extending through the housing 245 and configured to trigger the wireless transmitter 250 to send a signal to the wireless receiver 224; (4) a battery cover 254 to enclose a replaceable battery (not shown) that operates the battery-operable wireless transmitter 250; and (5) an ergonomic grip 256 defined on a portion of the exterior of the housing 245 to enable a user to easily hold and operate the inflator head 206. The second end 248 of the inflator head 206 includes threads 258 that enable threadable connection to a suitable inflation implement or device (e.g., the Shippers Products SUPERFLOW Product No. SF9090 (SUPERFLOW is a registered trademark of Signode Industrial Group LLC) or the Shippers Products TurboFlow™ Product No. 9010) to facilitate fluidly connecting the inflation hose 204 (and therefore the pressurized air generator 202) to a dunnage bag for inflation. The inflator head 206 may connect to any other suitable implement in any suitable manner (e.g., via a quick-connect coupling rather than threads). In other embodiments, the inflator head 206 includes an integrated inflation implement.

In certain embodiments, the wireless transmitter 250 of the inflator head 206 includes a radio-frequency transmitter and the wireless receiver 224 of the pressurized air generator 202 includes a radio-frequency receiver such that the wireless transmitter 250 can send radio signals to the wireless receiver 224 to control operation of the electric motor 218. In other embodiments, other communication mechanisms can be used, such as Wi-Fi™ or Bluetooth™ communication. Further, in certain embodiments, the actuatable button 252 that triggers the wireless transmitter 250 includes a momentary pushbutton configured to send a signal to the wireless receiver 224 while the momentary pushbutton is being depressed or otherwise actuated by a user. In other embodiments, the actuatable button 252 includes a maintained pushbutton configured to send a signal to the wireless receiver 224 upon the momentary pushbutton being depressed or otherwise actuated by a user. In such embodiments, the actuatable button 252 stops sending the signal to the wireless receiver 224 upon the user depressing the actuatable button 252 a second time.

In this embodiment, the battery 300 powers the electric motor 218 to operate the pressurized air generator 202 of the portable dunnage bag inflator 200. As best shown in FIGS. 1 to 3 and 11 to 13, the battery 300 includes: (1) a battery casing 302, (2) second wiring 304 that is electrically connected to contacts 306 of the battery 300 and extends from the battery casing 302, and (3) a second electrical connector 308 at an end of the second wiring 304 and that is removably connectable to the first electrical connector 222 of the portable dunnage bag inflator 200 to electrically connect the battery 300 and the electric motor 218 of the pressurized air generator 202 to power the electric motor 218. In certain embodiments, the battery 300 includes a 12 volt battery, though the battery 300 may supply any other voltage suitable to operate the electric motor 218. Any suitable type of battery may be used. In certain embodiments a non-rechargeable battery may be used.

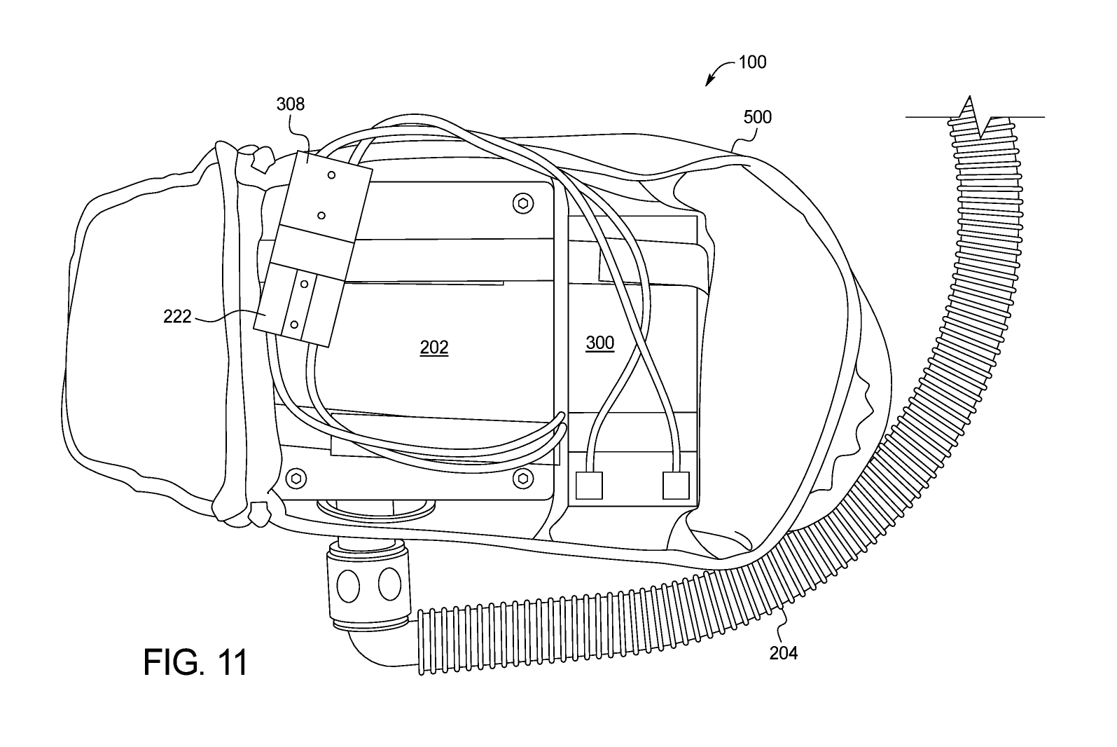

To prepare the portable dunnage bag inflator 200 for use, the pressurized air generator 202 is electrically connected to the battery 300 via connecting the first electrical connector 222 and the second electrical connector 308. The pressurized air generator 202 and the battery 300 are disposed and secured in the wearable container 500 with one or more straps (as best shown in FIG. 11). The inflator head 206 is connected to the second end 238 of the inflation hose 204, and the hose connector 242 is connected to the generator connector 230 to fluidly connect the inflation hose 204 to the pressurized air generator 202. An inflation implement (not shown) connectable to a dunnage bag is attached to the inflator head 206.

In operation, a user carries the portable dunnage bag inflator 200 and the battery 300 via the wearable container 500 toward a dunnage bag and connects the inflation implement (not shown) attached to the inflator head 206 to the dunnage bag. Once attached, the user depresses the actuatable button 252 of the inflator head 206 to trigger operation of the electric motor 218 to cause the impeller 228 to spin. This, in turn, (1) causes ambient air at atmospheric pressure to be drawn into the impeller 228 through the inlet 234 of the pressurized air generator 202, (2) causes the air to travel around the impeller 228 and out of the impeller 228 through the outlet 232, (3) causes the air to travel from the outlet 232 through the air passageway 240 of the inflation hose 204, and (4) causes the air to be expelled from the inflator head 206 and through the attached inflation implement (assuming the inflation implement is not in a configuration that prevents air flow). As a result, the air travels from the pressurized air generator, through the inflation implement, and into the dunnage bag, thus inflating the dunnage bag. When the dunnage bag is inflated to the desired pressure, the user removes the inflation implement attached to the inflator head 206 from the dunnage bag and manipulates the actuatable button 252 to turn off the electric motor 218.

In certain instances in which the actuatable button 252 includes a momentary pushbutton, the user continuously presses the actuatable button 252 to continue operation of the electric motor 218. In such instances, operation of the electric motor 218 stops when the user releases the actuatable button 252. In other instances in which the actuatable button 252 includes a maintained pushbutton, the user presses the actuatable button 252 to initiate operation of the electric motor 218. In such instances, the electric motor 218 continues to operate after the user releases the actuatable button 252 and stops operating upon the user subsequently repressing the actuatable button 252.

Since the portable dunnage bag inflator 200 includes an impeller-driven blower, the pressure of the air expelled through the inflation implement attached to the inflator head 206 into a dunnage bag is higher than atmospheric pressure. In certain embodiments, the pressure of the expelled air is 1.3 to 1.5 pounds per square inch gage pressure. Further, in certain embodiments, the flow rate of air through the portable dunnage bag inflator 200 is approximately 20 cubic feet per minute (approximately 0.566 cubic meters per minute), though it should be appreciated that the portable dunnage bag inflator 200 may be configured to operate at any suitable air flow rate (such as by varying the sizes of one or more of the components or the speed at which the impeller 228 rotates).

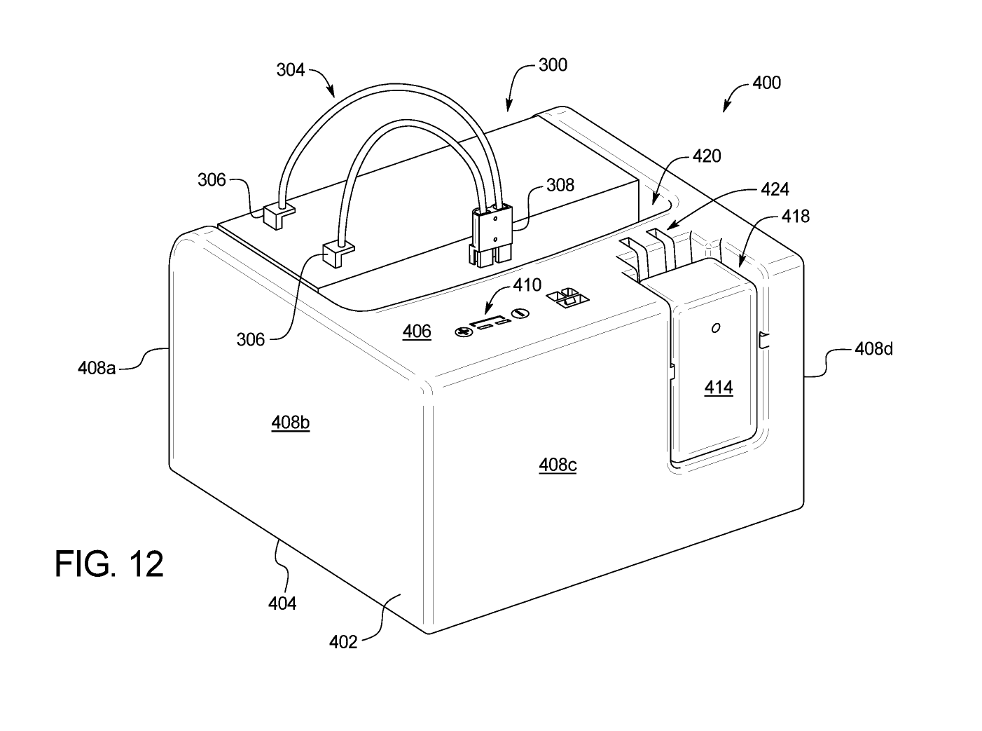

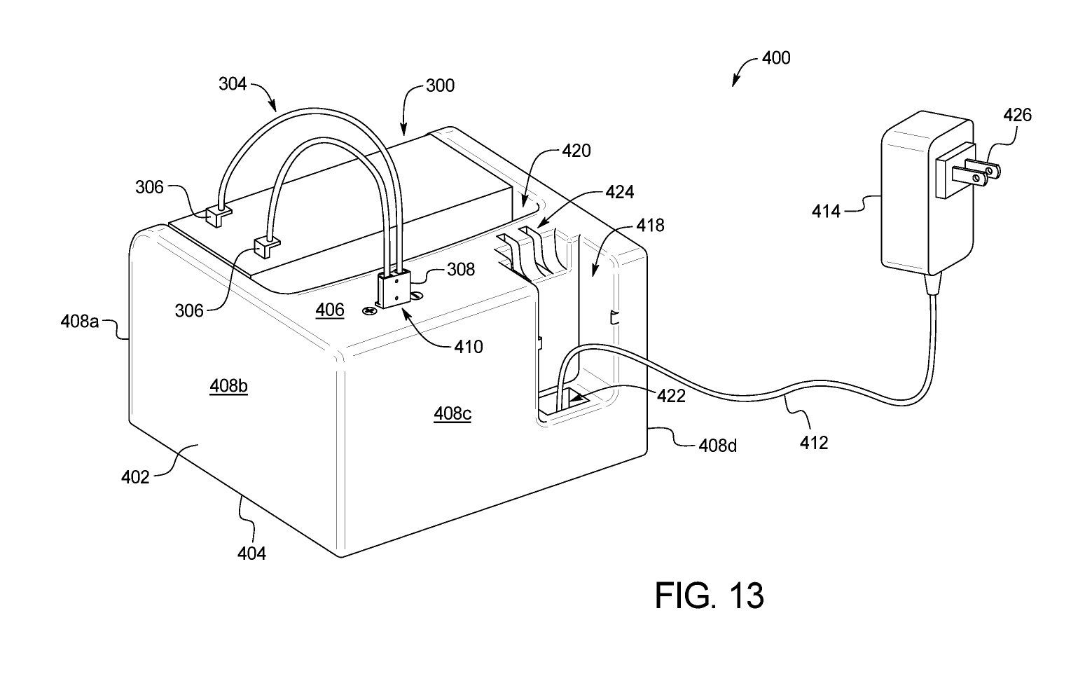

Over time, the battery 300 may become drained. The portable dunnage bag inflation system 100 of this embodiment includes the charging station 400 to recharge the battery. As best shown in FIGS. 12 and 13, the charging station 400 includes: (1) a charging station housing 402 having (a) a base 404, (b) an upper wall 406, and (c) four side walls 408a, 408b, 408c, 408d; (2) a socket 410 configured to receive the second wiring 304 and/or the second electrical connector 308 of the battery 300; (3) third wiring 412 electrically connected to the socket 410 and extending from the charging station housing 402; and (4) a charger 414 that is electrically connected to an end of the third wiring 412, electrically connected to the socket 410 via the third wiring 412, and electrically connectable to a power source such that the battery 300 is charged when the charger 414 is connected to the power source and the battery 300 is electrically connected to the socket 410.

As best shown in FIGS. 12 and 13, the socket 410 is located along the upper wall 406 of the charging station housing 402, though the socket 410 may be located along any suitable portion of the charging station housing 402 (such as one or more of the side walls 408a, 408b, 408c, 408d).

In this embodiment, the upper wall 406 and the side wall 408c define a first cavity 418 sized to receive the battery 300 when the battery 300 is being charged by the charging station 400, though the first cavity 418 may be defined by any suitable portion of the charging station housing 402 (such as one or more of the side walls 408a, 408b, 408c, 408d and/or the upper wall 406).

As best shown in FIGS. 12 and 13, the upper wall 406 and the side wall 408c define a second cavity 420 shaped to receive and store the charger 414 when the charging station 400 is not charging the battery 300. The second cavity 420 may be defined by any suitable portion of the charging station housing 402 (such as one or more of the side walls 408a, 408b, 408c, 408d and/or the upper wall 406). In this embodiment, the second cavity 420 defined by the upper wall 406 and the side wall 408c includes a recess 422 sized to receive and store the third wiring 412, which electrically connects the charger 414 to the socket 410, when the charging station 400 is not charging the battery 300. Further, in this embodiment, the second cavity 420 includes slots 424 shaped to receive prongs 426 of the charger 414 to enable the second cavity 420 to receive the charger 414.

To charge the battery 300 utilizing the charging station 400: (1) the battery 300 is inserted into the first cavity 418 such that the second wiring 304 and the second electrical connector 308 are accessible, (2) the second electrical connector 308 is inserted into the socket 410, (3) the charger 414 is removed from the second cavity 420, and (4) the charger is connected to a power source (e.g., the prongs 426 of the charger 414 are inserted into an electrical outlet).

In certain embodiments, the wearable container 500 is configured to contain the charging station 400. In some such embodiments, the wearable container 500 may simultaneously contain the portable pressurized air generator 202, the battery 300, and the charging station 400.

The embodiment of the portable dunnage bag inflation system illustrated in the accompanying Figures employs one example configuration of components and one example size and shape of each of the components. Other embodiments of the portable dunnage bag inflation system may employ different configurations of the components and/or components of different sizes or shapes.

In one embodiment: (1) the inflation hose 204, the inflator head 206, the housing base 210, the impeller housing 226, the impeller 228, the generator connector 230, the hose connector 242, the battery casing 302, and the charging station housing 402 are made of plastic; (2) the cover 216 is made of painted metal; (3) the electric motor 218, the first wiring 220, the first electrical connector 222, the wireless receiver 224, the wireless transmitter 250, the second wiring 304, the second electrical connector 308, the socket 410, the third wiring 412, and the charger 414 are made of metal and plastic; and (4) the wearable container 500 is made of fabric. It should be appreciated, however, that each component may be made of any suitable material or materials.

While the portable dunnage bag inflator 200 of the portable dunnage bag inflation system 100 is described herein as being configured to inflate dunnage bags, it should be appreciated that the portable dunnage bag inflator 200 of the present disclosure may, in certain embodiments, be configured to inflate items other than dunnage bags.

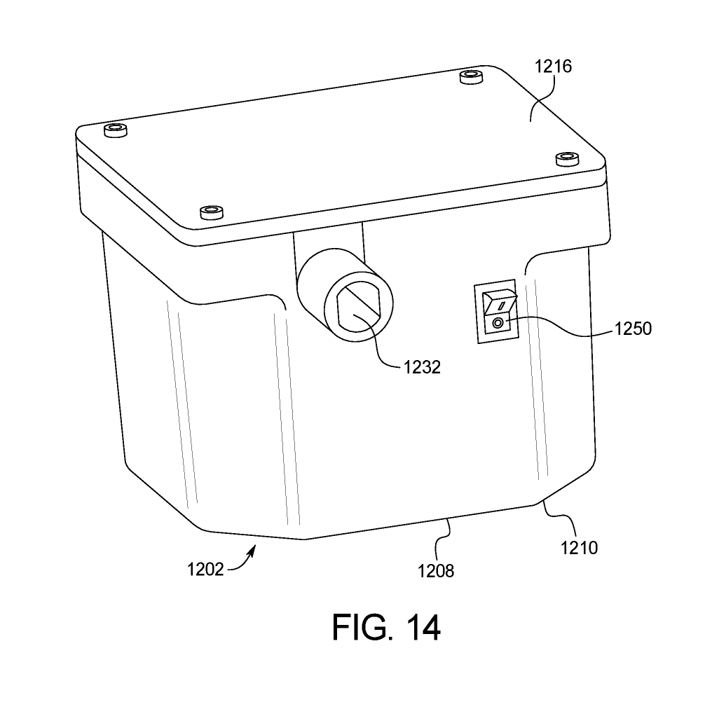

Referring now FIG. 14, an alternative example embodiment of the portable dunnage bag inflation system of the present disclosure is partially shown. In this alternative example embodiment, the portable dunnage bag inflation system includes: (1) an alternative portable dunnage bag inflator (as described above except including an alternative pressurized air generator 1202 described below); (2) the battery 300 (as described above and thus not needed to be shown again in FIG. 14) removably electrically connectable to and configured to power this alternative example portable dunnage bag inflator; (3) the charging station 400 (as described above and thus not needed to be shown again in FIG. 14) configured to charge the battery 300; and (4) the wearable container 500 (such as a backpack or other bag) (as described above and thus not needed to be shown again in FIG. 14) configured to contain this example portable dunnage bag inflator and the battery 300 to enable a user to carry and utilize this alternative example portable dunnage bag inflator in a mobile manner.

As described above, this alternative example portable dunnage bag inflator includes: (1) an alternative pressurized air generator 1202 (as generally described above and with the additional switch described below); (2) an inflation hose 204 (as described above and thus not needed to be shown again in FIG. 14) fluidly connectable to the pressurized air generator 1202 and configured to route pressurized air expelled from the pressurized air generator 1202; and (3) an inflator head 206 (as described above and thus not needed to be shown again in FIG. 14) removably connectable to the inflation hose 204 opposite the pressurized air generator 1202 and removably connectable to a dunnage bag (not shown) to facilitate filling the dunnage bag with the pressurized air expelled from the pressurized air generator 1202 through the inflation hose 204.

Like the pressurized air generator 202, the pressurized air generator 1202 includes: (1) a housing 1208 having (a) a housing base 1210 that includes four side walls (not labeled) and a bottom wall (not labeled) and (b) a cover 1216 attachable to a top of the housing base 1210 to enclose components mounted within the housing 1208; (2) an electric motor (not shown) mounted within the housing 1208 and configured to be powered via the battery 300; (3) first wiring (not shown) extending from the housing 1208 and electrically connected to the electric motor (not shown); (4) a first electrical connector (not shown) connected to an end of the first wiring (not shown) and configured to electrically connect the first wiring to the battery 300 to power the electric motor (as described above); (5) a wireless receiver (not shown) mounted within the housing 1208, communicatively connected to the electric motor (not shown), and configured to receive a wireless signal to control operation of the electric motor; (6) an impeller housing (not shown) mounted within the housing 1208; (7) an impeller (not shown) mounted within the impeller housing and operably connected to the electric motor such that the electric motor can drive the impeller; and (8) a generator connector (not shown) that extends through an opening of one of the side walls and protrudes from the side wall of the housing 1208 to define an outlet 1232 of the pressurized air generator 1202.

In the above described embodiments, the wireless receiver 224 includes a controller that controls fan operation of the electric motor 218 responsive to the received wireless signals. In other embodiments described above, the pressurized air generator 202 includes a controller that's separate from and communicatively connected to the wireless receiver 224. In these example embodiments, the wireless receiver 224 receives the wireless signals and routes them to (or sends other suitable signals to) the controller, which then controls operation of the electric motor 218 in accordance with those signals.

In the illustrated example embodiment of FIG. 14, the pressurized air generator 1202 includes a secondary hard wired electrical switch 1250 connected to and supported by one side of the housing 1208. In this illustrated embodiment, the electrical switch 1250 is configured to work independently of and separately from the RF switch (including components 250 and 252) to control operation of the electric motor 218. This switch 1250 enables a user to use this example alternative portable dunnage bag inflator if the RF switch is damaged or fails to operate. It should be appreciated that the switch 1250 can be any suitable switch in accordance with the present disclosure.

It should be understood that modifications and variations may be effected without departing from the scope of the novel concepts of the present disclosure, and it should be understood that this application is to be limited only by the scope of the appended claims.

The invention is claimed as follows:

1. A portable dunnage bag inflator comprising:
(a) an air generator including:
(i) a housing;
(ii) an outlet;
(iii) an impeller mounted within the housing;
(iv) a motor mounted within the housing and operably connected to the impeller to drive the impeller to expel air through the outlet; and
(v) a wireless receiver communicatively connected to the motor;
(b) a hose having a first end and a second end opposite the first end, the hose defining an air passageway extending between the first end and the second end, the first end attachable to the housing to fluidly connect the outlet of the air generator and the air passageway of the hose; and
(c) an inflator head connectable to the second end of the hose and including a wireless transmitter configured to communicate with the wireless receiver to operate the air generator.

2. The portable dunnage bag inflator of claim 1, wherein the air generator includes a generator connector that extends through an opening of the housing and protrudes from a wall of the housing to define the outlet of the air generator.

3. The portable dunnage bag inflator of claim 2, wherein the hose includes a hose connector attached to the first end of the hose, the hose connector connectable to the generator connector to fluidly connect the air passageway of the hose and the outlet of the air generator.

4. The portable dunnage bag inflator of claim 2, wherein the air generator includes wiring that is connected to the motor, extends from the housing, and is connectable to a battery.

5. The portable dunnage bag inflator of claim 4, wherein the air generator includes a first electrical connector at the end of the wiring, the first electrical connector connectable to a second electrical connector of the battery to electrically connect the motor and the battery.

6. The portable dunnage bag inflator of claim 1, wherein the wireless receiver of the air generator includes a radio-frequency receiver and the wireless transmitter of the inflator head includes a radio-frequency transmitter.

7. The portable dunnage bag inflator of claim 1, wherein the air generator is containable in a wearable container.

8. The portable dunnage bag inflator of claim 1, wherein the air generator is a pressurized air generator that expels air having a pressure between 1.3 and 1.5 pounds per square inch gage pressure.

9. The portable dunnage bag inflator of claim 1, wherein the wireless transmitter is battery powered.

10. The portable dunnage bag inflator of claim 1, wherein the inflator head includes an actuatable button configured to trigger the wireless transmitter to send a signal to the wireless receiver to operate the air generator.

11. The portable dunnage bag inflator of claim 10, wherein the actuatable button includes a momentary pushbutton configured to send the signal to the wireless receiver while the momentary pushbutton is being depressed.

12. The portable dunnage bag inflator of claim 10, wherein the actuatable button includes a maintained pushbutton configured to send the signal to the wireless receiver upon the momentary pushbutton being depressed.

13. The portable dunnage bag inflator of claim 1, wherein the inflator head includes threads that facilitate connection to an inflation implement that's fluidly connectable to a dunnage bag.

14. The portable dunnage bag inflator of claim 1, which includes a secondary hard wired electrical switch.

15. A portable dunnage bag inflation system comprising:
(a) a dunnage bag inflator including:
(i) an air generator including a housing, an outlet, an impeller mounted within the housing, and a motor mounted within the housing and operably connected to the impeller to drive the impeller to expel air through the outlet; and
(ii) first wiring that extends from the air generator, is electrically connected to the motor, and is electrically connectable to second wiring of a battery to power the motor; and
(b) a charging station including:
(i) a charging station housing;
(ii) a socket configured to receive the second wiring of the battery to charge the battery; and
(iii) a charger electrically connected to the socket of the charging station, the charger electrically connectable to a power source to charge the battery when the socket receives the second wiring of the battery.

16. The portable dunnage bag inflation system of claim 15, wherein the charging station housing includes an upper wall on which the socket of the charging station is located.

17. The portable dunnage bag inflation system of claim 16, wherein the upper wall and an adjacent first side wall of the charging station housing define a first cavity sized to receive the battery.

18. The portable dunnage bag inflation system of claim 16, wherein the upper wall and an adjacent second side wall of the charging station housing define a second cavity shaped to receive the charger.

19. The portable dunnage bag inflation system of claim 18, wherein the second cavity includes a recess sized to receive third wiring that electrically connects the charger to the socket of the charging station.

20. The portable dunnage bag inflation system of claim 18, wherein the second cavity includes slots shaped to receive prongs of the charger.

21. A portable dunnage bag inflation system comprising:
(a) a dunnage bag inflator including:
(i) an air generator including a housing that defines an outlet, an impeller mounted within the housing, and a motor mounted within the housing and operably connected to the impeller to drive the impeller to expel air through the outlet;
(ii) first wiring that extends from the air generator and is electrically connected to the motor; and
(iii) a first electrical connector at an end of the first wiring; and
(b) a battery including:
(i) a battery casing;
(ii) second wiring that extends from the battery casing; and
(iii) a second electrical connector at an end of the second wiring, the second electrical connector connectable to the first electrical connector to electrically connect the battery to the air generator.
